(19) United States
(12) Patent Application Publication
(10) Pub. No.: US 2025/0284881 A1
(43) Pub. Date: Sep. 11, 2025

(54) EMAIL MESSAGE PROCESSING FOR FORM AUTO-COMPLETION

(71) Applicant: Capital One Services, LLC, McLean, VA (US)

(72) Inventors: Mohamed SECK, Aubrey, TX (US); Judith RODRIGUEZ, Falls Church, VA (US)

(21) Appl. No.: 18/597,539

(22) Filed: Mar. 6, 2024

(51) Int. Cl. G06F 40/174; H04L 51/42

(52) U.S. Cl. CPC G06F 40/174; H04L 51/42

(57) ABSTRACT

In some implementations, a processing system may receive a plurality of email messages from an email service. The processing system may provide the plurality of email messages to a classification model in order to receive an indication of at least one relevant email message in the plurality of email messages. The processing system may extract, from the at least one relevant email message, a snippet corresponding to a field in the form. The processing system may generate a draft copy of the form that includes the snippet in the field and may output, to a user device, an indication that the snippet was added to the form.

### BACKGROUND

Transferring data from email messages into forms may consume significant amounts of computing resources. For example, a user may search for email messages, which increases network overhead, and may copy-and-paste information from the email messages into forms, which consumes power and processing resources at a user device.

### SUMMARY

Some implementations described herein relate to a system for processing a plurality of email messages to auto-complete a form. The system may include one or more memories and one or more processors communicatively coupled to the one or more memories. The one or more processors may be configured to receive the plurality of email messages from an email service. The one or more processors may be configured to provide the plurality of email messages to a classification model in order to receive an indication of at least one relevant email message in the plurality of email messages. The one or more processors may be configured to extract, from the at least one relevant email message, a snippet corresponding to a field in the form. The one or more processors may be configured to generate a draft copy of the form that includes the snippet in the field. The one or more processors may be configured to output, to a user device, an indication that the snippet was added to the form. The one or more processors may be configured to provide the snippet to a machine learning model in order to receive a suggested change for an organization associated with the email service. The one or more processors may be configured to output, to the user device, an indication of the suggested change.

Some implementations described herein relate to a method of processing a plurality of email messages to auto-complete a form. The method may include receiving, at a processing system, the plurality of email messages from an email service. The method may include providing, by the processing system, the plurality of email messages to a classification model in order to receive an indication of at least one relevant email message in the plurality of email messages. The method may include extracting, by the processing system and from the at least one relevant email message, a snippet corresponding to a field in the form. The method may include generating, by the processing system, a draft copy of the form that includes the snippet in the field. The method may include outputting, from the processing system and to a user device, an indication that the snippet was added to the form.

Some implementations described herein relate to a non-transitory computer-readable medium that stores a set of instructions for authorizing processing of a plurality of email messages to auto-complete a form. The set of instructions, when executed by one or more processors of a device, may cause the device to transmit, to a processing system, an authorization to access an email service hosting the plurality of email messages. The set of instructions, when executed by one or more processors of the device, may cause the device to receive, from the processing system, an indication of at least one relevant email message in the plurality of email messages. The set of instructions, when executed by one or more processors of the device, may cause the device to receive, from the processing system, an indication that a snippet, from the at least one relevant email message, was added to a draft copy of the form. The set of instructions, when executed by one or more processors of the device, may cause the device to receive, from the processing system, an indication of a suggested change, for an organization associated with the email service, based on the snippet.

### BRIEF DESCRIPTION OF THE DRAWINGS

FIGS. 1A-1E are diagrams of an example implementation relating to processing email messages for form auto-completion, in accordance with some embodiments of the present disclosure.

FIGS. 2A-2B are diagrams of example user interfaces (UIs) associated with email messages processed for form auto-completion, in accordance with some embodiments of the present disclosure.

FIG. 3 is a diagram illustrating an example of training and using a machine learning model in connection with systems and/or methods described herein, in accordance with some embodiments of the present disclosure.

FIG. 4 is a diagram of an example environment in which systems and/or methods described herein may be implemented, in accordance with some embodiments of the present disclosure.

FIG. 5 is a diagram of example components of one or more devices of FIG. 4, in accordance with some embodiments of the present disclosure.

FIG. 6 is a flowchart of an example process relating to processing email messages for form auto-completion, in accordance with some embodiments of the present disclosure.

FIG. 7 is a flowchart of an example process relating to authorizing access to email messages for form auto-completion, in accordance with some embodiments of the present disclosure.

### DETAILED DESCRIPTION

The following detailed description of example implementations refers to the accompanying drawings. The same reference numbers in different drawings may identify the same or similar elements.

Transferring data from email messages into forms consumes computing resources. For example, a user may search for email messages, which increases network overhead because a user device of the user and an email service hosting the email messages communicate during every search. In order to reduce latency in searching for email messages, the user may configure a set of filters at the email service. The set of filters may additionally reduce network overhead that would have been increased by searching for the email messages.

Regardless of whether the user searches for email messages or configures filters to identify the email messages, the user may copy-and-paste information from the email messages into forms. Each copy-and-paste consumes power and processing resources at the user device as well as increasing memory overhead because a clipboard (e.g., provided by an operating system (OS) of the user device) consumes available memory storage in order to enable copy-and-paste.

Some implementations described herein enable identification of relevant email messages (e.g., using a clustering model) and extraction of snippets from the relevant email messages for auto-insertion into fields of a form (e.g., a tax form or another type of form). The clustering model may have increased accuracy as compared with rule-based filters, which further reduces a quantity of searches performed by a user in completing the form and thus further reduces network overhead. Additionally, as a result of auto-insertion of the snippets, power and processing resources are conserved, and memory overhead is reduced, that a user device otherwise would have consumed in copy-and-paste actions.

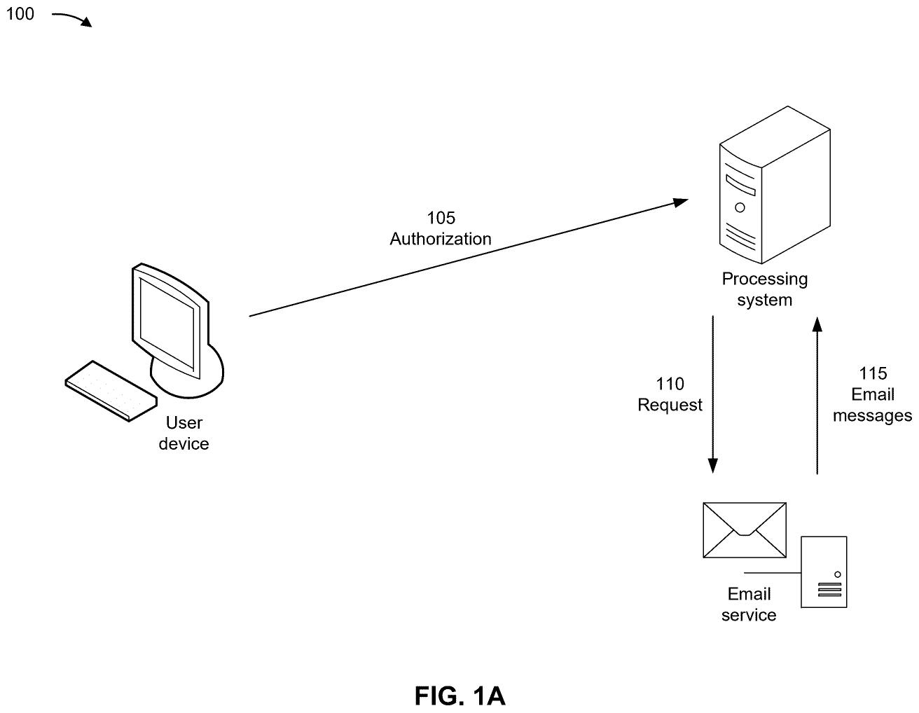

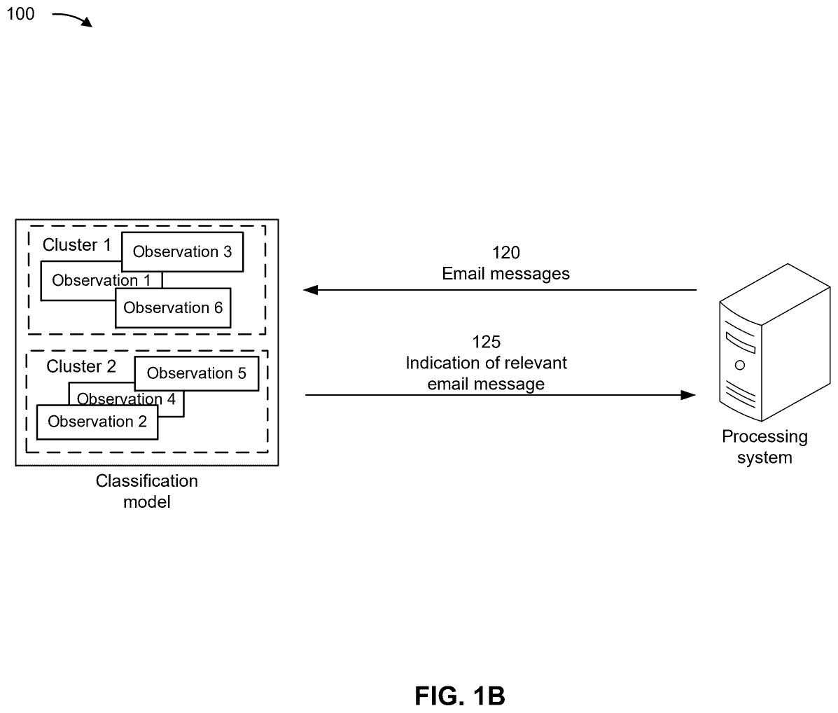

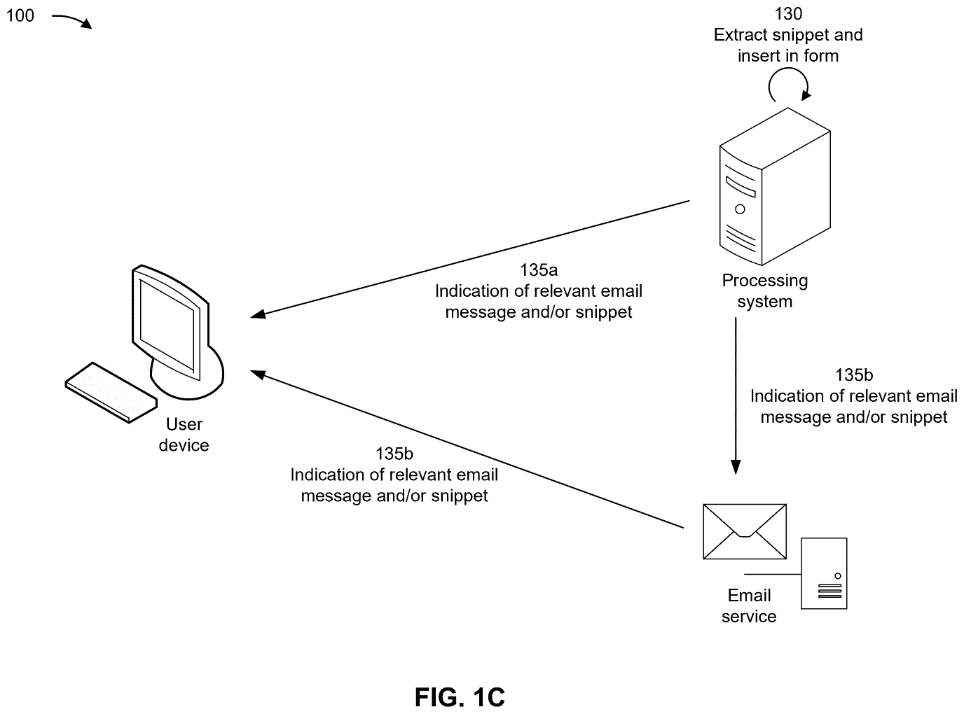

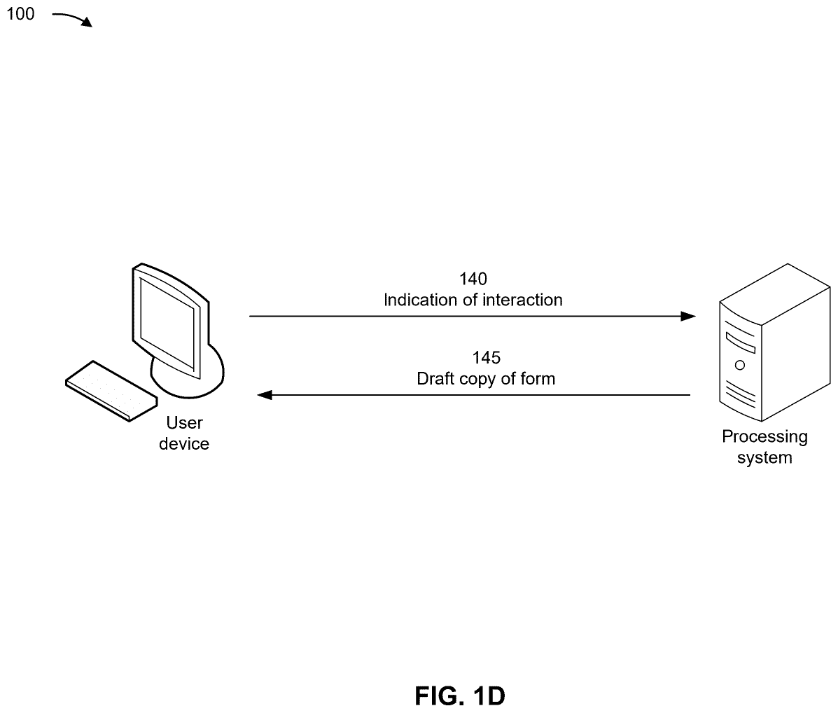

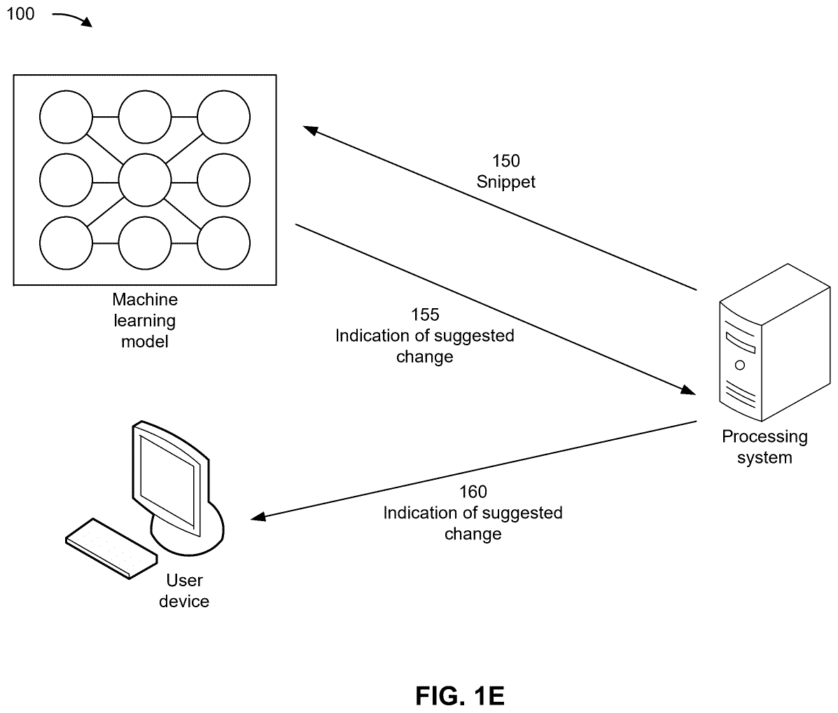

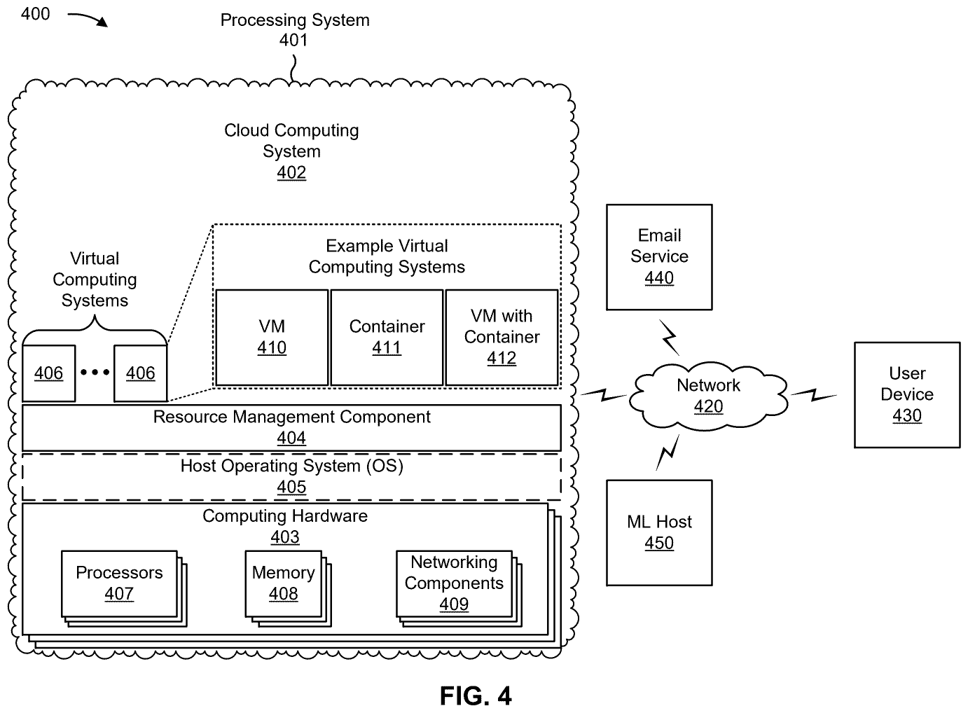

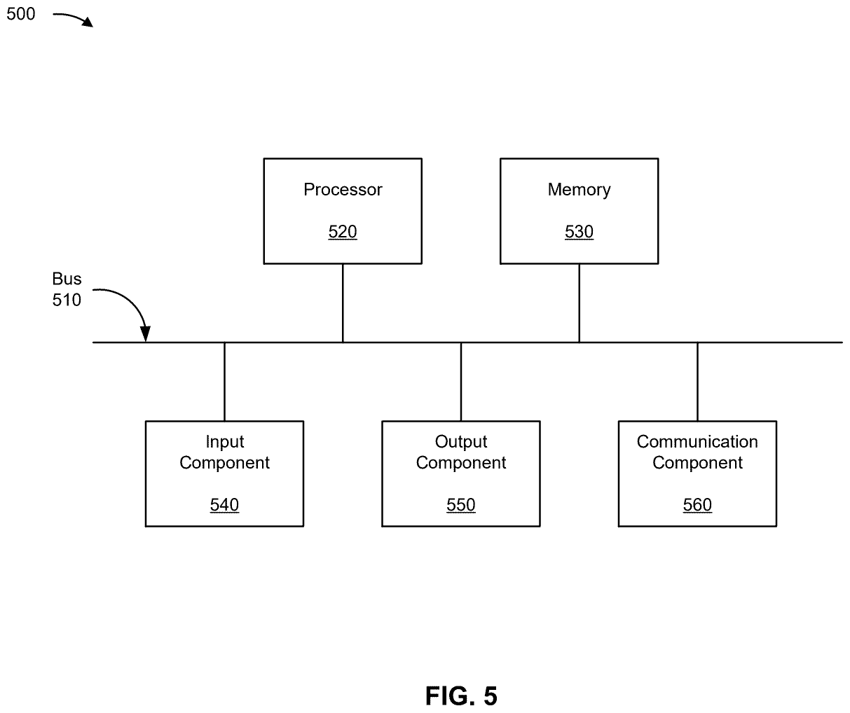

FIGS. 1A-1E are diagrams of an example 100 associated with processing email messages for form auto-completion. As shown in FIGS. 1A-1E, example 100 includes a user device, a processing system, a clustering model and a machine learning (ML) model (e.g., provided by an ML host), and an email service. These devices are described in more detail in connection with FIGS. 4 and 5.

As shown in FIG. 1A and by reference number 105, the user device may transmit, and the processing system may receive, an authorization to access the email service. The email service may host a plurality of email messages (e.g., belonging to an account that is associated with the authorization). The authorization may include a set of credentials (e.g., a username and password, a passcode, a private key, a certificate, and/or biometric information, among other examples) associated with a user of the email service (e.g., a user of the account). Additionally, or alternatively, the authorization may include a data structure representing permission to access an application programming interface (API) associated with the email service. The user of the email service may be the same as a user of the user device, or a different user may instruct the user device to transmit the authorization on behalf of the user of the email service.

In some implementations, the user of the user device may provide input (e.g., using an input component of the user device) that triggers the user device to transmit the authorization to access the email service. For example, the user device may output a UI to the user (e.g., via an output component of the user device), and the user may interact with the UI to provide the input that triggers the user device to transmit the authorization. In some implementations, a web browser (or another type of application executed by the user device) may navigate to a website controlled by (or at least associated with) the processing system, and the web browser may output the UI to represent the website.

As shown by reference number 110, the processing system may transmit, and the email service may receive, a request for the plurality of email messages. The request may include a hypertext transfer protocol (HTTP) request, a file transfer protocol (FTP) request, and/or an API call, among other examples. The request may include (e.g., in a header and/or as an argument) an indication of the user (e.g., a name and/or another type of identifier) and/or the account (e.g., a username and/or another type of identifier) associated with the plurality of emails. The request may include the authorization described in connection with reference number 105.

As shown by reference number 115, the email service may transmit, and the processing system may receive, the plurality of email messages. The email service may transmit, and the processing system may receive, the plurality of email messages in response to the request described in connection with reference number 110. For example, the email service may transmit, and the processing system may receive, a response (e.g., an HTTP response, an FTP response, and/or as a return from an API function) including the plurality of email messages. Additionally with, or alternatively to, receiving the plurality of email messages on demand (e.g., via a pull from the processing system), the processing system may receive email messages periodically and/or as available (e.g., via a push from the email service). For example, the processing system may subscribe to updates from the email service such that the email service transmits email messages periodically (e.g., according to a schedule) and/or in real time (or at least near real time) (e.g., as new email messages become available).

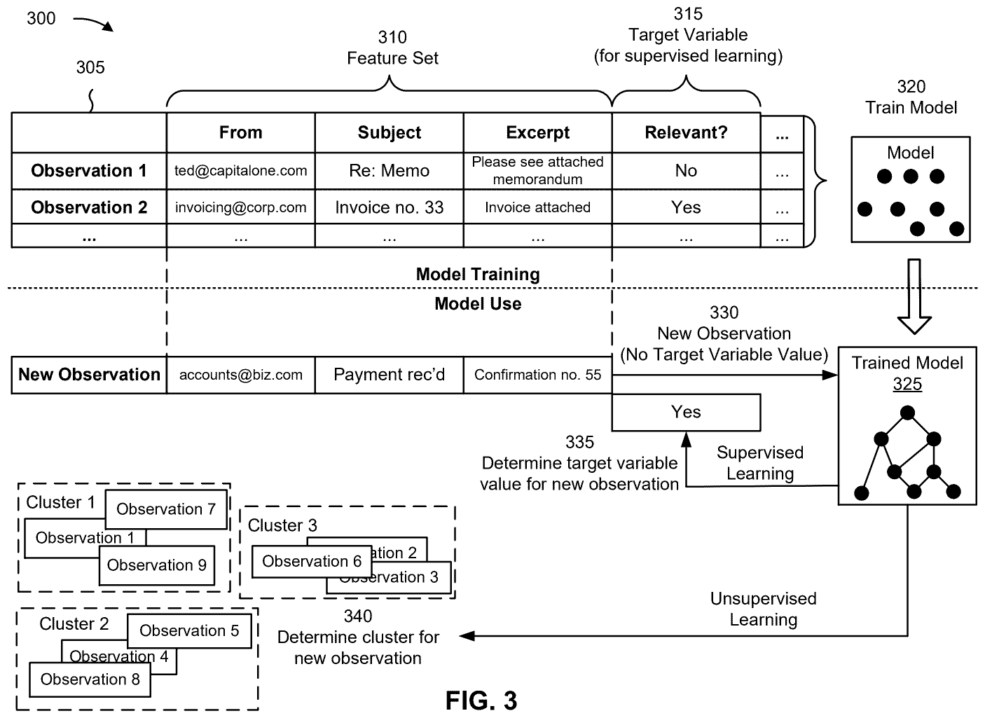

As shown in FIG. 1B and by reference number 120, the processing system may provide the plurality of email messages to the classification model. For example, the processing system may transmit, and the ML host may receive, a request including the plurality of email messages. The classification model may be trained (e.g., by the ML host and/or a device at least partially separate from the ML host) using a labeled set of email messages (e.g., for supervised learning). The classification model may be configured to determine a relevance (e.g., a binary indicator of relevance, a relevance score, or another type of indicator) for an email message (e.g., whether the email message includes information for a field in a form). Additionally, or alternatively, the classification model may be trained using an unlabeled set of email messages (e.g., for deep learning). The classification model may be configured to cluster email messages (e.g., where email messages in one cluster include information for a field in a form and email messages in another cluster do not). In some implementations, the classification model may be trained and applied as described in connection with FIG. 3. Additionally, or alternatively, the classification model may use natural language processing (NLP) and/or a neural network to determine relevance of the plurality of email messages.

As shown by reference number 125, the processing system may receive an indication, of a relevant email message (e.g., at least one relevant email message) in the plurality of email messages, from the classification model (e.g., from the ML host). For example, the classification model may output a plurality of relevance indicators, where each relevance indicator corresponds to an email message in the plurality of email messages (e.g., on a one-to-one basis). Additionally, or alternatively, the classification model may output a cluster indicator for each email message in the plurality of email messages. Therefore, the processing system may determine relevance of each email message by mapping the cluster indicator for the email message to a relevance indicator (e.g., based on a data structure mapping clusters to relevance).

Although the example 100 is described in connection with one-dimensional relevance, other examples may include multi-dimensional relevance indicated by the classification model. For example, the classification model may output, for an email message, a relevance indicator (and/or a cluster indicator) that associates the email message with a corresponding form out of a plurality of possible forms. Accordingly, different email messages may be classified as relevant for different forms (or for none of the plurality of possible forms).

By using the classification model to identify the relevant email, the processing system conserves network overhead that otherwise would have been increased by communications between the user device and the email service (e.g., if the user were to search for the relevant email). Although the example 100 is described in connection with the processing system applying the classification model, other examples may include the email service applying the classification model. For example, the email service may provide the plurality of email messages to the classification model (e.g., by transmitting the plurality of email messages to the ML host) and may receive the indication of the relevant email message from the classification model (e.g., from the ML host). Accordingly, the email service may transmit, and the processing system may receive, the relevant email message rather than the plurality of email messages.

As shown in FIG. 1C and by reference number 130, the processing system may extract, from the relevant email message, a snippet (e.g., corresponding to a field in the form) and may generate a draft copy of the form that includes the snippet in the field. The processing system may copy the snippet directly (e.g., moving a donation amount from the relevant email message to column (h) on Form 8283 from the Internal Revenue Service (IRS), or moving an amount receivable from the relevant email message to a revenue field on a profit and loss statement in QuickBooks®, among other examples). Additionally, or alternatively, the processing system may operate (e.g., mathematically) on the snippet to generate a resultant and may copy the resultant to the field (e.g., adding a donation amount from the relevant email message to a previous donation amount and moving the resultant to line 11 on Schedule A from the IRS, or adding an amount receivable from the relevant email message to a previous revenue amount and moving the resultant to a revenue field on a profit and loss statement in QuickBooks, among other examples).

In some implementations, the processing system may identify the snippet using the classification model. For example, the processing system may receive an indication of the snippet from the classification model (e.g., from the ML host). Accordingly, the classification model may be configured to identify snippets from any email messages classified as relevant and to output indications of the snippets.

Additionally, or alternatively, the processing system may identify the snippet by mapping the snippet to a pattern associated with the field. For example, the processing system may map a dollar amount in the relevant email message to a pattern associated with the field (e.g., a pattern of $*.** or $**.** or *,***.**, among other examples). In another example, the processing system may map a date in the relevant email message to a pattern associated with the field (e.g., a pattern of **/**/** or **/**/****, among other examples).

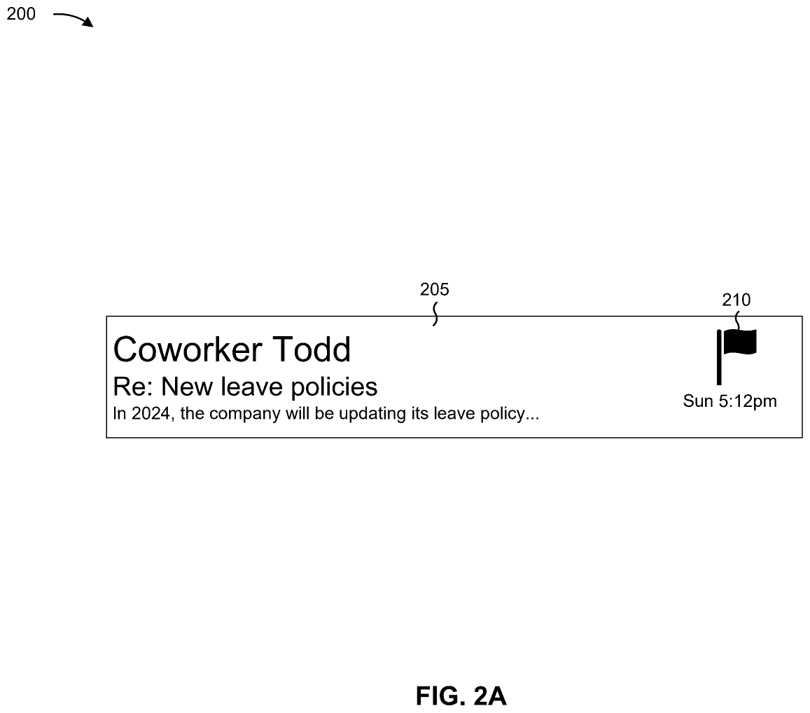

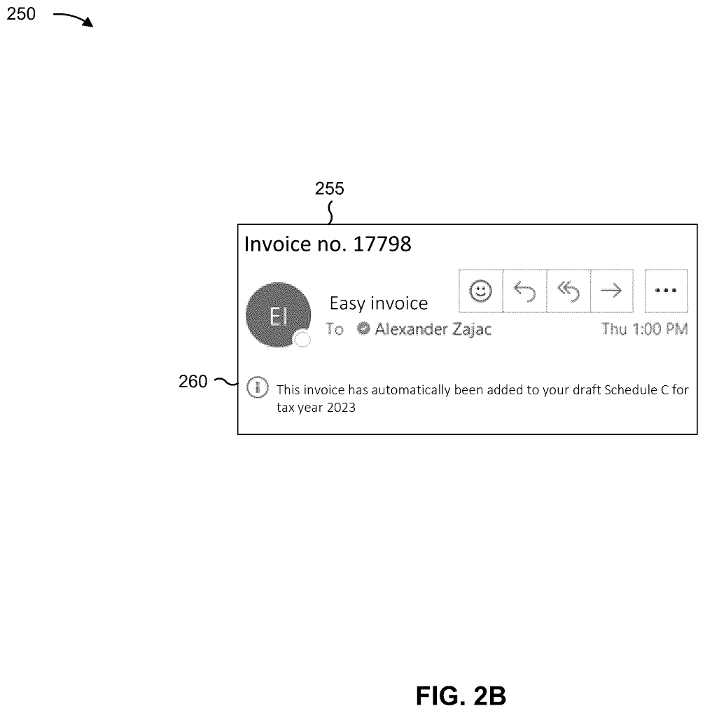

By automatically completing the draft copy of the form, the processing system conserves power and processing resources, and reduces memory overhead, that the user device otherwise would have consumed in copy-and-paste actions. As shown by reference number 135a, the processing system may transmit, and the user device may receive, an indication of the relevant email message and/or an indication that the snippet was added to the form. The indication of the relevant email message may be included in instructions for a UI (e.g., as described in connection with FIG. 2A). The indication that the snippet, from the relevant email message, was added to the draft copy of the form may similarly be included in instructions for a UI (e.g., as described in connection with FIG. 2B).

In some implementations, as shown by reference number 135b, the processing system may output the indication of the relevant email message and/or the indication that the snippet was added to the form to the user device via the email service. For example, the processing system may output instructions for a graphical indication included in a preview of the relevant email message (e.g., as described in connection with FIG. 2A or FIG. 2B).

Although the example 100 is described in connection with the classification model identifying the relevant email message, other examples may additionally include the user device providing input to assist with identifying additional relevant email messages. The user device may transmit, and the processing system may receive, an indication of an additional email message in the plurality of email messages. For example, the user device may interact with a preview of the additional email message (e.g., as described in connection with FIG. 2A) to trigger the user device to transmit the indication. Accordingly, the processing system may, in response to the indication, extract a snippet from the additional email message and add the snippet to the draft copy of the form. Therefore, the processing system may transmit an indication that the snippet was added to (the draft copy of) the form, either directly to the user device or to the user device via the email service.

Additionally, or alternatively, the user device may provide input to assist with identifying false positives from the classification model. The user device may transmit, and the processing system may receive, an indication that the relevant email message, in the plurality of email messages, is actually irrelevant. For example, the user device may interact with a preview of the relevant email message (e.g., as described in connection with FIG. 2A) to trigger the user device to transmit the indication. Accordingly, the processing system may, in response to the indication, remove the snippet (e.g., previously extracted from the relevant email message, as described above) from the draft copy of the form. Therefore, the processing system may transmit an indication that the snippet was removed from (the draft copy of) the form, either directly to the user device or to the user device via the email service.

As shown in FIG. 1D and by reference number 140, the user device may transmit, and the processing system may receive, an indication of an interaction with the indication that the snippet was added to the form. For example, the user may interact with a graphical indication included in a preview of the relevant email message (e.g., as described in connection with FIG. 2B).

As shown by reference number 145, the processing system may transmit, and the user device may receive, the draft copy of the form. The processing system may transmit, and the user device may receive, the draft copy in response to the indication of the interaction. The user device may output the draft copy to the user for review (e.g., using an output component of the user device). For example, the user device may generate a preview of a portable document format (pdf) file, a spreadsheet, and/or another type of file that encodes the draft copy.

As shown in FIG. 1E and by reference number 150, the processing system may provide the snippet (and/or the relevant email message) to the ML model. For example, the processing system may transmit, and the ML host may receive, a request including the snippet (and/or the relevant email message). The ML model may be trained (e.g., by the ML host and/or a device at least partially separate from the ML host) using a labeled set of email messages (e.g., for supervised learning). Additionally, or alternatively, the ML model may be trained using an unlabeled set of email messages (e.g., for deep learning). The ML model may be configured to determine a suggested change for an organization associated with the email service (e.g., based on the snippet and/or the relevant email message). For example, the ML model may determine a suggested change associated with a supplier (e.g., by identifying a better supplier based on the relevant email message). In another example, the ML model may determine a suggested change associated with a customer (e.g., by identifying a better pricing structure based on the relevant email message).

In some implementations, the ML model may include a regression algorithm (e.g., linear regression or logistic regression), which may include a regularized regression algorithm (e.g., Lasso regression, Ridge regression, or Elastic-Net regression). Additionally, or alternatively, the ML model may include a decision tree algorithm, which may include a tree ensemble algorithm (e.g., generated using bagging and/or boosting), a random forest algorithm, or a boosted trees algorithm. A model parameter may include an attribute of a model that is learned from data input into the model (e.g., information about front-end devices). For example, for a regression algorithm, a model parameter may include a regression coefficient (e.g., a weight). For a decision tree algorithm, a model parameter may include a decision tree split location, as an example.

Additionally, the ML host (and/or a device at least partially separate from the ML host) may use one or more hyperparameter sets to tune the ML model. A hyperparameter may include a structural parameter that controls execution of a machine learning algorithm by the processing system, such as a constraint applied to the machine learning algorithm. Unlike a model parameter, a hyperparameter is not learned from data input into the model. An example hyperparameter for a regularized regression algorithm includes a strength (e.g., a weight) of a penalty applied to a regression coefficient to mitigate overfitting of the model. The penalty may be applied based on a size of a coefficient value (e.g., for Lasso regression, such as to penalize large coefficient values), may be applied based on a squared size of a coefficient value (e.g., for Ridge regression, such as to penalize large squared coefficient values), may be applied based on a ratio of the size and the squared size (e.g., for Elastic-Net regression), and/or may be applied by setting one or more feature values to zero (e.g., for automatic feature selection). Example hyperparameters for a decision tree algorithm include a tree ensemble technique to be applied (e.g., bagging, boosting, a random forest algorithm, and/or a boosted trees algorithm), a number of features to evaluate, a number of observations to use, a maximum depth of each decision tree (e.g., a number of branches permitted for the decision tree), or a number of decision trees to include in a random forest algorithm.

Other examples may use different types of models, such as a Bayesian estimation algorithm, a k-nearest neighbor algorithm, an a priori algorithm, a k-means algorithm, a support vector machine algorithm, a neural network algorithm (e.g., a convolutional neural network algorithm), and/or a deep learning algorithm.

As shown by reference number 155, the processing system may receive an indication of the suggested change from the ML model (e.g., from the ML host). For example, the ML model may output text encoding the suggested change.

As shown by reference number 160, the processing system may transmit, and the user device may receive, an indication of the suggested change. The suggested change may be for the organization associated with the email service and based on the snippet, as described above. The user device may output the draft copy to the user for review (e.g., using an output component of the user device).

By using techniques as described in connection with FIGS. 1A-1E, the processing system identifies the relevant email message using the clustering model and extracts the snippet from the relevant email message for auto-insertion into the form. Applying the clustering model conserves power and processing resources at the processing system as compared with executing numerous searches from the user device while the user completes the form. Additionally, the processing system generating the draft copy of the form conserves power and processing resources, and reduces memory overhead, as compared with the user device executing numerous copy-and-paste actions while the user generates the draft copy of the form.

As indicated above, FIGS. 1A-1E are provided as an example. Other examples may differ from what is described with regard to FIGS. 1A-1E.

FIGS. 2A and 2B are diagrams of example UIs 200 and 250, respectively, associated with email messages processed for form auto-completion. The example UIs 200 and/or 250 may be output by a user device (e.g., based on instructions from a processing system). These devices are described in more detail in connection with FIGS. 4 and 5.

As shown in FIG. 2A, the example UI 200 may include a preview 205 for an email message. The preview 205 in FIG. 2A includes an indication of a sender (e.g., “Coworker Todd”), an indication of a subject line (e.g., “Re: New leave policies”), an initial portion of a body (e.g., “In 2024, the company will be updating its leave policy”), and an indication of a time of receipt (e.g., “Sun 5:12 pm”). As further shown in FIG. 2A, the example UI 200 may include a graphical indication 210 that the email message is relevant (e.g., determined as described in connection with FIG. 1B). In some implementations, a user may interact with the graphical indication 210 in order to trigger the user device to transmit an indication that the email message is actually irrelevant. A preview of an additional email message may include a graphical indication that the email message is irrelevant (or may omit the graphical indication 210 in order to indicate irrelevance). Therefore, the user may interact with the graphical indication of irrelevance (or with a space where the graphical indication 210 would have been) in order to trigger the user device to transmit an indication that the additional email message is relevant.

As shown in FIG. 2B, the example UI 250 may similarly include a preview 255 for an email message. The preview 255 in FIG. 2B includes an indication of a sender (e.g., “Easy invoice”), a recipient (e.g., “Alexander Zajac”), an indication of a subject line (e.g., “Invoice no. 17798”), and an indication of a time of receipt (e.g., “Thu 1:00 PM”). As further shown in FIG. 2B, the example UI 250 may include a graphical indication 260 that a snippet, from the email message, was added to a form (e.g., “Schedule C for tax year 2023”). In some implementations, a user may interact with the graphical indication 260 in order to view a draft copy of the form (e.g., in order to trigger the user device to transmit a request to the processing system and receive the draft copy in response to the request).

As indicated above, FIGS. 2A-2B are provided as examples. Other examples may differ from what is described with regard to FIGS. 2A-2B. For example, the preview 205 may omit elements shown in FIG. 2A and/or may include additional elements not shown in FIG. 2A. Similarly, the preview 255 may omit elements shown in FIG. 2B and/or may include additional elements not shown in FIG. 2B.

FIG. 3 is a diagram illustrating an example 300 of training and using a machine learning model in connection with processing email messages for form auto-completion. The machine learning model training and usage described herein may be performed using a machine learning system. The machine learning system may include or may be included in a computing device, a server, a cloud computing environment, or the like, such as a processing system described in more detail elsewhere herein.

As shown by reference number 305, a machine learning model may be trained using a set of observations. The set of observations may be obtained from training data (e.g., historical data), such as data gathered during one or more processes described herein. In some implementations, the machine learning system may receive the set of observations (e.g., as input) from an email server, as described elsewhere herein.

As shown by reference number 310, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from email server. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of a “From” line, a second feature of a “Subject” line, a third feature of an excerpt (e.g., from a body of each observation), and so on. As shown, for a first observation, the first feature may have a value of “ted@capitalone.com,” the second feature may have a value of “Re: Memo,” the third feature may have a value of “Please see attached memorandum,” and so on. These features and feature values are provided as examples, and may differ in other examples. For example, the feature set may include one or more of the following features: a “To” line, a file type of an attachment, an excerpt from an attachment, and/or a date and/or a time associated with transmission or reception, among other examples.

As shown by reference number 315, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 300, the target variable is relevance, which has a value of No for the first observation.

The feature set and target variable described above are provided as examples, and other examples may differ from what is described above. For example, the target variable may include a relevance score or a multi-dimensional relevance indicator (e.g., where each dimension is associated with a different form). Additionally, or alternatively, the target variable may include a snippet, from each observation, to copy into a form.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 320, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 325 to be used to analyze new observations.

As an example, the machine learning system may obtain training data for the set of observations based on email messages. For example, an administrator may label email messages stored on the email server as relevant or irrelevant in order to generate the set of observations for training. In another example, an administrator may label snippets of email messages and corresponding fields in a form (or a plurality of forms) for the snippets.

As shown by reference number 330, the machine learning system may apply the trained machine learning model 325 to a new observation, such as by receiving a new observation and inputting the new observation to the trained machine learning model 325. As shown, the new observation may include a first feature of “accounts@biz.com,” a second feature of “Payment rec'd,” a third feature of “Confirmation no. 55,” and so on, as an example. The machine learning system may apply the trained machine learning model 325 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 325 may predict a value of Yes for the target variable of relevance for the new observation, as shown by reference number 335. Based on this prediction, the machine learning system may provide a first recommendation, may provide output for determination of a first recommendation, may perform a first automated action, and/or may cause a first automated action to be performed (e.g., by instructing another device to perform the automated action), among other examples. The first recommendation may include, for example, a recommendation to extract a snippet from the new observation. The first automated action may include, for example, extracting a snippet from the new observation for insertion into a field of a form.

As another example, if the machine learning system were to predict a value of No for the target variable of relevance, then the machine learning system may provide a second (e.g., different) recommendation (e.g., a recommendation to ignore the new observation) and/or may perform or cause performance of a second (e.g., different) automated action (e.g., refraining from extracting a snippet from the new observation).

In some implementations, the trained machine learning model 325 may classify (e.g., cluster) the new observation in a cluster, as shown by reference number 340. The observations within a cluster may have a threshold degree of similarity. As an example, if the machine learning system classifies the new observation in a first cluster (e.g., a cluster associated with a first form), then the machine learning system may provide a third recommendation, such as a recommendation to extract a snippet from the new observation for a field in the first form. Additionally, or alternatively, the machine learning system may perform a third automated action and/or may cause a third automated action to be performed (e.g., by instructing another device to perform the automated action) based on classifying the new observation in the first cluster, such as extracting a snippet from the new observation for insertion into a field of the first form.

As another example, if the machine learning system were to classify the new observation in a second cluster (e.g., a cluster associated with a second form), then the machine learning system may provide a fourth (e.g., different) recommendation (e.g., a recommendation to extract a snippet from the new observation for a field in the second form) and/or may perform or cause performance of a fourth (e.g., different) automated action, such as extracting a snippet from the new observation for insertion into a field of the second form.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 325 may be re-trained using feedback information. For example, feedback may be provided to the machine learning model. The feedback may be associated with actions performed based on the recommendations provided by the trained machine learning model 325 and/or automated actions performed, or caused, by the trained machine learning model 325. In other words, the recommendations and/or actions output by the trained machine learning model 325 may be used as inputs to re-train the machine learning model (e.g., a feedback loop may be used to train and/or update the machine learning model). For example, the feedback information may include an indication that an email message (classified as relevant by the machine learning model) is actually irrelevant and/or an indication that an additional email message (classified as irrelevant by the machine learning model) is relevant.

In this way, the machine learning system may apply a rigorous and automated process to identifying relevant email messages. The machine learning model may have increased accuracy as compared with rule-based filters, which reduces a quantity of searches performed by a user in completing the form. As a result, network overhead is reduced. Additionally, power and processing resources are conserved at the email server that otherwise would have been consumed in executing the searches from the user.

As indicated above, FIG. 3 is provided as an example. Other examples may differ from what is described in connection with FIG. 3.

FIG. 4 is a diagram of an example environment 400 in which systems and/or methods described herein may be implemented. As shown in FIG. 4, environment 400 may include a processing system 401, which may include one or more elements of and/or may execute within a cloud computing system 402. The cloud computing system 402 may include one or more elements 403-412, as described in more detail below. As further shown in FIG. 4, environment 400 may include a network 420, a user device 430, an email service 440, and/or an ML host 450. Devices and/or elements of environment 400 may interconnect via wired connections and/or wireless connections.

The cloud computing system 402 may include computing hardware 403, a resource management component 404, a host OS 405, and/or one or more virtual computing systems 406. The cloud computing system 402 may execute on, for example, an Amazon Web Services platform, a Microsoft Azure platform, or a Snowflake platform. The resource management component 404 may perform virtualization (e.g., abstraction) of computing hardware 403 to create the one or more virtual computing systems 406. Using virtualization, the resource management component 404 enables a single computing device (e.g., a computer or a server) to operate like multiple computing devices, such as by creating multiple isolated virtual computing systems 406 from computing hardware 403 of the single computing device. In this way, computing hardware 403 can operate more efficiently, with lower power consumption, higher reliability, higher availability, higher utilization, greater flexibility, and lower cost than using separate computing devices.

The computing hardware 403 may include hardware and corresponding resources from one or more computing devices. For example, computing hardware 403 may include hardware from a single computing device (e.g., a single server) or from multiple computing devices (e.g., multiple servers), such as multiple computing devices in one or more data centers. As shown, computing hardware 403 may include one or more processors 407, one or more memories 408, and/or one or more networking components 409. Examples of a processor, a memory, and a networking component (e.g., a communication component) are described elsewhere herein.

The resource management component 404 may include a virtualization application (e.g., executing on hardware, such as computing hardware 403) capable of virtualizing computing hardware 403 to start, stop, and/or manage one or more virtual computing systems 406. For example, the resource management component 404 may include a hypervisor (e.g., a bare-metal or Type 1 hypervisor, a hosted or Type 2 hypervisor, or another type of hypervisor) or a virtual machine monitor, such as when the virtual computing systems 406 are virtual machines 410. Additionally, or alternatively, the resource management component 404 may include a container manager, such as when the virtual computing systems 406 are containers 411. In some implementations, the resource management component 404 executes within and/or in coordination with a host operating system 405.

A virtual computing system 406 may include a virtual environment that enables cloud-based execution of operations and/or processes described herein using computing hardware 403. As shown, a virtual computing system 406 may include a virtual machine 410, a container 411, or a hybrid environment 412 that includes a virtual machine and a container, among other examples. A virtual computing system 406 may execute one or more applications using a file system that includes binary files, software libraries, and/or other resources required to execute applications on a guest operating system (e.g., within the virtual computing system 406) or the host operating system 405.

Although the processing system 401 may include one or more elements 403-412 of the cloud computing system 402, may execute within the cloud computing system 402, and/or may be hosted within the cloud computing system 402, in some implementations, the processing system 401 may not be cloud-based (e.g., may be implemented outside of a cloud computing system) or may be partially cloud-based. For example, the processing system 401 may include one or more devices that are not part of the cloud computing system 402, such as device 500 of FIG. 5, which may include a standalone server or another type of computing device. The processing system 401 may perform one or more operations and/or processes described in more detail elsewhere herein.

The network 420 may include one or more wired and/or wireless networks. For example, the network 420 may include a cellular network, a public land mobile network (PLMN), a local area network (LAN), a wide area network (WAN), a private network, the Internet, and/or a combination of these or other types of networks. The network 420 enables communication among the devices of the environment 400.

The user device 430 may include one or more devices capable of receiving, generating, storing, processing, and/or providing information associated with email messages, as described elsewhere herein. The user device 430 may include a communication device and/or a computing device. For example, the user device 430 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 430 may communicate with one or more other devices of environment 400, as described elsewhere herein.

The email service 440 may include one or more devices capable of receiving, generating, storing, processing, providing, and/or routing information associated with email messages, as described elsewhere herein. The email service 440 may include a communication device and/or a computing device. For example, the email service 440 may include a server, such as an application server, a client server, a web server, a database server, a host server, a proxy server, a virtual server (e.g., executing on computing hardware), or a server in a cloud computing system. In some implementations, the email service 440 may include computing hardware used in a cloud computing environment. For example, the email service 440 may be at least partially integrated (e.g., virtually, physically, and/or logically) with the processing system 401. The email service 440 may include an email system, such as Microsoft Outlook® or Gmail®, among other examples. The email service 440 may communicate with one or more other devices of environment 400, as described elsewhere herein.

The ML host 450 may include one or more devices capable of receiving, generating, storing, processing, and/or providing information associated with classification models and/or machine learning models, as described elsewhere herein. The ML host 450 may include a communication device and/or a computing device. For example, the ML host 450 may include a server, a database server, an application server, a client server, a web server, a host server, a proxy server, a virtual server (e.g., executing on computing hardware), a server in a cloud computing system, a device that includes computing hardware used in a cloud computing environment, or a similar type of device. The ML host 450 may communicate with one or more other devices of environment 400, as described elsewhere herein.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of the environment 400 may perform one or more functions described as being performed by another set of devices of the environment 400.

FIG. 5 is a diagram of example components of a device 500 associated with processing email messages for form auto-completion. The device 500 may correspond to a user device 430, an email service 440, and/or an ML host 450. In some implementations, a user device 430, an email service 440, and/or an ML host 450 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

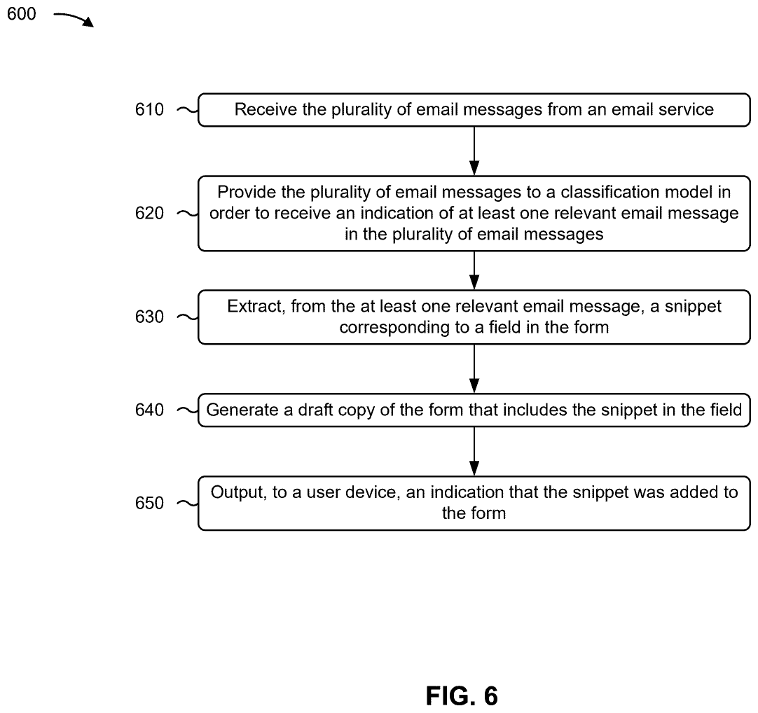

FIG. 6 is a flowchart of an example process 600 associated with processing email messages for form auto-completion. In some implementations, one or more process blocks of FIG. 6 may be performed by a processing system 401. In some implementations, one or more process blocks of FIG. 6 may be performed by another device or a group of devices separate from or including the processing system 401, such as a user device 430, an email service 440, and/or an ML host 450. Additionally, or alternatively, one or more process blocks of FIG. 6 may be performed by one or more components of the device 500, such as processor 520, memory 530, input component 540, output component 550, and/or communication component 560.

As shown in FIG. 6, process 600 may include receiving the plurality of email messages from an email service (block 610). For example, the processing system 401 (e.g., using processor 520, memory 530, and/or communication component 560) may receive the plurality of email messages from an email service, as described above in connection with reference number 115 of FIG. 1A. As an example, the processing system 401 may transmit a request to the email service and may receive the plurality of email messages in response to the request. Additionally with, or alternatively to, receiving the plurality of email messages on demand (e.g., via a pull from the processing system 401), the processing system 401 may receive email messages periodically and/or as available (e.g., via a push from the email service).

As further shown in FIG. 6, process 600 may include providing the plurality of email messages to a classification model in order to receive an indication of at least one relevant email message in the plurality of email messages (block 620). For example, the processing system 401 (e.g., using processor 520, memory 530, and/or communication component 560) may provide the plurality of email messages to a classification model in order to receive an indication of at least one relevant email message in the plurality of email messages, as described above in connection with reference numbers 120 and 125 of FIG. 1B. As an example, the processing system 401 may transmit a request, including the plurality of email messages, to an ML host associated with the classification model. The classification model may be configured to determine a relevance (e.g., a binary indicator of relevance, a relevance score, or another type of indicator) for an email message (e.g., whether the email message includes information for a field in a form). Additionally, or alternatively, the classification model may be configured to cluster email messages (e.g., where email messages in one cluster include information for a field in a form and email messages in another cluster do not). In some implementations, the classification model may be trained and applied as described in connection with FIG. 3.

As further shown in FIG. 6, process 600 may include extracting, from the at least one relevant email message, a snippet corresponding to a field in the form (block 630). For example, the processing system 401 (e.g., using processor 520 and/or memory 530) may extract, from the at least one relevant email message, a snippet corresponding to a field in the form, as described above in connection with reference number 130 of FIG. 1C. As an example, the processing system 401 may receive an indication of the snippet from the classification model. Additionally, or alternatively, the processing system 401 may identify the snippet by mapping the snippet to a pattern associated with the field.

As further shown in FIG. 6, process 600 may include generating a draft copy of the form that includes the snippet in the field (block 640). For example, the processing system 401 (e.g., using processor 520 and/or memory 530) may generate a draft copy of the form that includes the snippet in the field, as described above in connection with reference number 130 of FIG. 1C. As an example, the processing system 401 may copy the snippet directly into the field or may operate (e.g., mathematically) on the snippet to generate a resultant and copy the resultant to the field.

As further shown in FIG. 6, process 600 may include outputting, to a user device, an indication that the snippet was added to the form (block 650). For example, the processing system 401 (e.g., using processor 520, memory 530, and/or output component 550) may output, to a user device, an indication that the snippet was added to the form, as described above in connection with reference numbers 135a and/or 135b of FIG. 1C. As an example, the indication that the snippet, from the relevant email message, was added to the draft copy of the form may be included in instructions for a UI (e.g., as described in connection with FIG. 2B).

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1E, 2A-2B, and/or 3. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

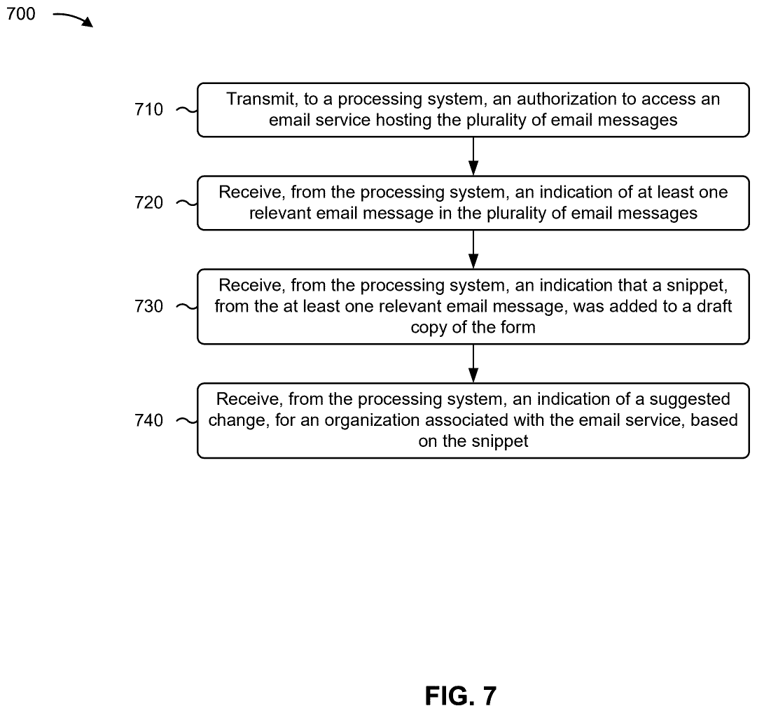

FIG. 7 is a flowchart of an example process 700 associated with authorizing access to email messages for form auto-completion. In some implementations, one or more process blocks of FIG. 7 may be performed by a user device 430. In some implementations, one or more process blocks of FIG. 7 may be performed by another device or a group of devices separate from or including the user device 430, such as a processing system 401, an email service 440, and/or an ML host 450. Additionally, or alternatively, one or more process blocks of FIG. 7 may be performed by one or more components of the device 500, such as processor 520, memory 530, input component 540, output component 550, and/or communication component 560.

As shown in FIG. 7, process 700 may include transmitting, to a processing system, an authorization to access an email service hosting the plurality of email messages (block 710). For example, the user device 430 (e.g., using processor 520, memory 530, and/or communication component 560) may transmit, to a processing system, an authorization to access an email service hosting the plurality of email messages, as described above in connection with reference number 105 of FIG. 1A. As an example, the authorization may include a set of credentials (e.g., a username and password, a passcode, a private key, a certificate, and/or biometric information, among other examples) associated with a user of the email service (e.g., a user of an account to which the plurality of email messages belong). Additionally, or alternatively, the authorization may include a data structure representing permission to access an API associated with the email service.

As further shown in FIG. 7, process 700 may include receiving, from the processing system, an indication of at least one relevant email message in the plurality of email messages (block 720). For example, the user device 430 (e.g., using processor 520, memory 530, and/or communication component 560) may receive, from the processing system, an indication of at least one relevant email message in the plurality of email messages, as described above in connection with reference numbers 135a and/or 135b of FIG. 1C. As an example, the indication of the at least one relevant email message may be included in instructions for a UI (e.g., as described in connection with FIG. 2A).

As further shown in FIG. 7, process 700 may include receiving, from the processing system, an indication that a snippet, from the at least one relevant email message, was added to a draft copy of the form (block 730). For example, the user device 430 (e.g., using processor 520, memory 530, and/or communication component 560) may receive, from the processing system, an indication that a snippet, from the at least one relevant email message, was added to a draft copy of the form, as described above in connection with reference numbers 135a and/or 135b of FIG. 1C. As an example, the indication that the snippet was added to the form may be included in instructions for a UI (e.g., as described in connection with FIG. 2B).

As further shown in FIG. 7, process 700 may include receiving, from the processing system, an indication of a suggested change, for an organization associated with the email service, based on the snippet (block 740). For example, the user device 430 (e.g., using processor 520, memory 530, and/or communication component 560) may receive, from the processing system, an indication of a suggested change, for an organization associated with the email service, based on the snippet, as described above in connection with reference number 160 of FIG. 1E. As an example, the suggested change may be associated with a supplier (e.g., indicating a better supplier based on the at least one relevant email message). In another example, the suggested change may be associated with a customer (e.g., indicating a better pricing structure based on the at least one relevant email message).

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1E, 2A-2B, and/or 3. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for processing a plurality of email messages to auto-complete a form, the system comprising:
one or more memories; and
one or more processors, communicatively coupled to the one or more memories, configured to:
receive the plurality of email messages from an email service;
provide the plurality of email messages to a classification model in order to receive an indication of at least one relevant email message in the plurality of email messages;
extract, from the at least one relevant email message, a snippet corresponding to a field in the form;
generate a draft copy of the form that includes the snippet in the field;
output, to a user device, an indication that the snippet was added to the form;
provide the snippet to a machine learning model in order to receive a suggested change for an organization associated with the email service; and
output, to the user device, an indication of the suggested change.

2. The system of claim 1, wherein the one or more processors are configured to:
receive, from the user device, an authorization associated with the email service; and
transmit, to the email service, a request for the plurality of email messages, the request including the authorization,
wherein the plurality of email messages are received in response to the request.

3. The system of claim 1, wherein the classification model uses at least one of natural language processing or a neural network.

4. The system of claim 1, wherein the classification model is used by the email service, and the indication of the at least one relevant email message is received from the email service.

5. The system of claim 1, wherein the one or more processors, to extract the snippet, are configured to:
receive, from the classification model, an indication of the snippet; and
copy the snippet from the at least one relevant email message into the field.

6. The system of claim 1, wherein the one or more processors, to extract the snippet, are configured to:
map the snippet to a pattern associated with the field; and
copy the snippet from the at least one relevant email message into the field.

7. The system of claim 1, wherein the suggested change for the organization is associated with a supplier or with a customer.

8. A method of processing a plurality of email messages to auto-complete a form, comprising:
receiving, at a processing system, the plurality of email messages from an email service;
providing, by the processing system, the plurality of email messages to a classification model in order to receive an indication of at least one relevant email message in the plurality of email messages;
extracting, by the processing system and from the at least one relevant email message, a snippet corresponding to a field in the form;
generating, by the processing system, a draft copy of the form that includes the snippet in the field; and
outputting, from the processing system and to a user device, an indication that the snippet was added to the form.

9. The method of claim 8, further comprising:
outputting instructions for a graphical indication of the at least one relevant email message.

10. The method of claim 8, wherein outputting the indication that the snippet was added to the form comprises:
outputting instructions for a graphical indication included in a preview of the at least one relevant email message.

11. The method of claim 8, further comprising:
transmitting, to the email service, a request for the plurality of email messages, the request including a set of credentials,
wherein the plurality of email messages are received in response to the request.

12. The method of claim 8, further comprising:
receiving, from the user device, an indication of an interaction with the indication that the snippet was added to the form; and
transmitting, to the user device, the draft copy of the form in response to the indication of the interaction.

13. The method of claim 8, wherein providing the plurality of email messages to the classification model comprises:
transmitting, to a machine learning host, a request with the plurality of email messages; and
receiving, from the machine learning host, a response including the indication of the at least one relevant email message.

14. A non-transitory computer-readable medium storing a set of instructions for authorizing processing of a plurality of email messages to auto-complete a form, the set of instructions comprising:
one or more instructions that, when executed by one or more processors of a device, cause the device to:
transmit, to a processing system, an authorization to access an email service hosting the plurality of email messages;
receive, from the processing system, an indication of at least one relevant email message in the plurality of email messages;
receive, from the processing system, an indication that a snippet, from the at least one relevant email message, was added to a draft copy of the form; and
receive, from the processing system, an indication of a suggested change, for an organization associated with the email service, based on the snippet.

15. The non-transitory computer-readable medium of claim 14, wherein the authorization includes a set of credentials associated with a user of the email service.

16. The non-transitory computer-readable medium of claim 14, wherein the authorization includes a data structure representing permission to access an application programming interface associated with the email service.

17. The non-transitory computer-readable medium of claim 14, wherein the one or more instructions, when executed by the one or more processors, cause the device to:
output a representation of the indication of the at least one relevant email message.

18. The non-transitory computer-readable medium of claim 14, wherein the one or more instructions, when executed by the one or more processors, cause the device to:
output a representation of the indication that the snippet was added to the draft copy of the form.

19. The non-transitory computer-readable medium of claim 14, wherein the one or more instructions, when executed by the one or more processors, cause the device to:
receive, from the processing system, the draft copy of the form.

20. The non-transitory computer-readable medium of claim 14, wherein the one or more instructions, when executed by the one or more processors, cause the device to:
transmit, to the processing system, an indication of an additional email message in the plurality of email messages; and
receive, from the processing system, an indication that a snippet, from the additional email message, was added to the draft copy of the form.
